(19) United States
(12) Patent Application Publication
(10) Pub. No.: US 2020/0191583 A1
(43) Pub. Date: Jun. 18, 2020

(54) MATCHING METHOD, MATCHING SERVER, MATCHING SYSTEM, AND STORAGE MEDIUM

(71) Applicant: HONDA MOTOR CO., LTD., Tokyo (JP)

(72) Inventors: Takaaki Ishikawa, Wako-shi (JP); Mafuyu Koseki, Tokyo (JP); Naohide Aizawa, Tokyo (JP); Hidekazu Shintani, Wako-shi (JP)

(73) Assignee: HONDA MOTOR CO., LTD., Tokyo (JP)

(21) Appl. No.: 16/689,341

(22) Filed: Nov. 20, 2019

(30) Foreign Application Priority Data
Dec. 12, 2018 (JP) 2018-232807

(51) Int. Cl. G01C 21/34; G06Q 30/02; G06F 16/9535; G01C 21/28; G07C 5/00; H04L 29/08

(52) U.S. Cl. CPC G01C 21/3438; G06Q 30/02; H04L 67/12; G01C 21/28; G07C 5/008; G06F 16/9535

(57) ABSTRACT

A matching method for matching of a vehicle user is provided. The matching method comprises: acquiring first and second user information including boarding characteristic information of a first and second user; determining, based on the acquired first and second user information, whether compatibility between the first and second user is high; acquiring information concerning a position of a moving schedule of each of the first and second user; determining whether there is a possibility that the first user approaches the second user within a predetermined range of the position of the acquired moving schedule of the first user; and providing, to the first user, information concerning the second user for which it is determined in the determining that the compatibility is high, and that there is the possibility that the approach occurs.

### CROSS-REFERENCE TO RELATED APPLICATION

This application claims priority to and the benefit of Japanese Patent Application No. 2018-232807 filed on Dec. 12, 2018, the entire disclosure of which is incorporated herein by reference.

### BACKGROUND OF THE INVENTION

### Field of the Invention

The present invention relates to a matching method, a matching server, a matching system, and a storage medium.

### Description of the Related Art

There is proposed a matching system configured to acquire, based on the information of a user, the degree of association with each of other users and provide information concerning other users with high degrees of association to the user. For example, patent literature 1 proposes a user introduction apparatus that extracts and introduces combinations of users of high compatibility (for example, Japanese Patent Laid-Open No. 2003-30306). The user introduction apparatus proposed in Japanese Patent Laid-Open No. 2003-30306 diagnoses compatibility based on individual information such as the personality or interest/taste of a user himself/herself, desired conditions, and answers to questionnaires.

However, if a user inputs information by himself/herself, he/she may input personally embroidered information. In this case, even if matching is performed, a deviation may occur between the personality of the user viewed from another user and the personality of the user input by the user himself/herself. This may make it impossible to implement matching with an actually compatible partner.

In some cases, the personality or interest/taste of a user is reflected on a vehicle the user gets in, speech/action and the manner of driving observed during driving of the vehicle or during boarding, and a habit such as considerations to the periphery. In this case, when matching of the user is performed based on information concerning the vehicle the user gets in, speech/action and the manner of driving observed during driving of the vehicle or during the boarding, and a habit such as considerations to the periphery, matching with a more compatible user may be implemented.

In addition, when a point with a potential of an encounter with a compatible user is proposed near the traveling route of the user, a more natural encounter may be provided.

### SUMMARY OF THE INVENTION

It is an object of the present invention to provide a chance to an encounter of users based on information associated with a vehicle a user drives or gets in.

According to the present invention, there is provided a matching method executed by a matching server configured to perform matching of a vehicle user, comprising: acquiring first user information including boarding characteristic information of a first user and second user information including boarding characteristic information of a second user; determining, based on the first user information and the second user information acquired in the acquiring first user information and the second user information, whether compatibility between the first user and the second user is high; acquiring information concerning a position of a moving schedule of each of the first user and the second user; determining whether there is a possibility that the first user approaches the second user within a predetermined range of the position of the moving schedule of the first user acquired in the acquiring the information concerning the position of the moving schedule; and providing, to the first user, information concerning the second user for which it is determined in the determining whether the compatibility is high, that the compatibility is high, and it is determined in the determining whether there is the possibility that there is the possibility that the approach occurs.

Further features of the present invention will become apparent from the following description of exemplary embodiments (with reference to the attached drawings).

### BRIEF DESCRIPTION OF THE DRAWINGS

FIG. 1 is a system diagram of a matching system according to the embodiment;

FIG. 2 is a block diagram of a matching server according to the embodiment;

FIG. 3 is a block diagram of a vehicle according to the embodiment;

FIG. 4 is a sequence chart of processing of the matching system according to the embodiment;

FIG. 5 is a view showing an example of the data structure of data stored in a boarding history information database according to the embodiment;

FIG. 6 is a view showing an example of the data structure of data stored in a user information database according to the embodiment;

FIG. 7 is a view showing an example of the data structure of data stored in a route information database according to the embodiment;

FIG. 8 is a flowchart showing processing of the matching server according to the embodiment; and

FIG. 9 is a view showing an example of a screen displayed on the notification unit of the vehicle according to the embodiment.

### DESCRIPTION OF THE EMBODIMENTS

An embodiment of the present invention will now be described with reference to the accompanying drawings.

This embodiment provides a system that accepts a matching request from a vehicle a user (vehicle user) drives or gets in, and upon determining that there is another user who is compatible with the user and may encounter, transmits recommendation information including information concerning the other user to the user.

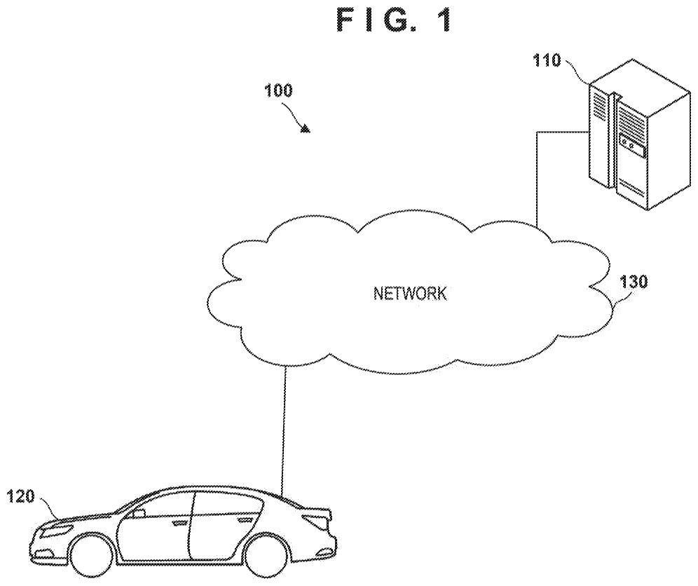

A matching system according to this embodiment will be described with reference to FIG. 1. A matching system 100 includes a matching server 110 and a vehicle 120. The matching server 110 and the vehicle 120 are communicably connected by a network 130. Note that although FIG. 1 illustrates only one vehicle 120, the matching system 100 includes a plurality of vehicles 120.

The matching server 110 is a computer that manages information concerning a user and boarding characteristic information of the user, as will be described later. The matching server 110 accepts a matching request from the vehicle 120, and upon determining that there is another user who is compatible with the user driving the vehicle 120 and may encounter, transmits recommendation information as a response to the matching request.

The vehicle 120 can communicate with the matching server 110 via wireless communication and transmits a matching request to the matching server 110. In addition, the vehicle 120 transmits boarding history information including information concerning a boarding behavior to the matching server 110. Note that a description will be made assuming that the vehicle here means an automobile driven by the user. However, the vehicle 120 may include a two-wheeled vehicle such as a motorbike and an automated driving vehicle the user gets in. That is, the boarding behavior includes a behavior caused by driving of the vehicle by the user, a behavior caused by an operation of the vehicle by the user, and a behavior that is caused when the user is boarding on the vehicle.

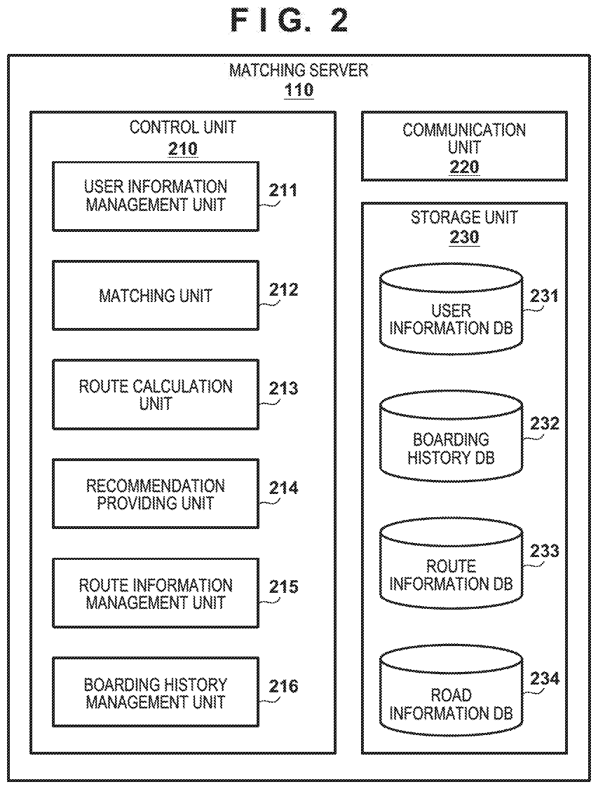

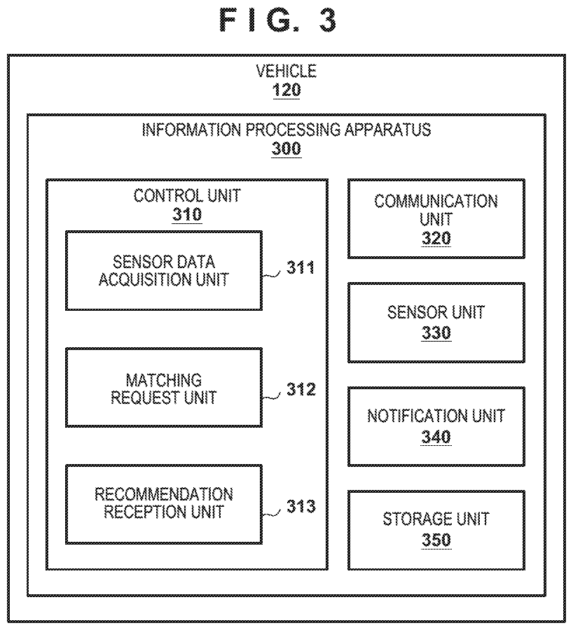

The arrangements of the matching server 110 and the vehicle 120 will be described below with reference to FIGS. 2 and 3.

### Matching Server

FIG. 2 is a block diagram of the matching server 110 according to this embodiment. Referring to FIG. 2, the matching server 110 includes a control unit 210, a communication unit 220, and a storage unit 230.

The control unit 210 includes a CPU and a RAM (Random Access Memory), and controls the matching server 110 by executing various kinds of programs stored in the storage unit 230. By executing the various kinds of programs, the control unit 210 functions as a user information management unit 211, a matching unit 212, a route calculation unit 213, a recommendation providing unit 214, a route information management unit 215, and a boarding history management unit 216.

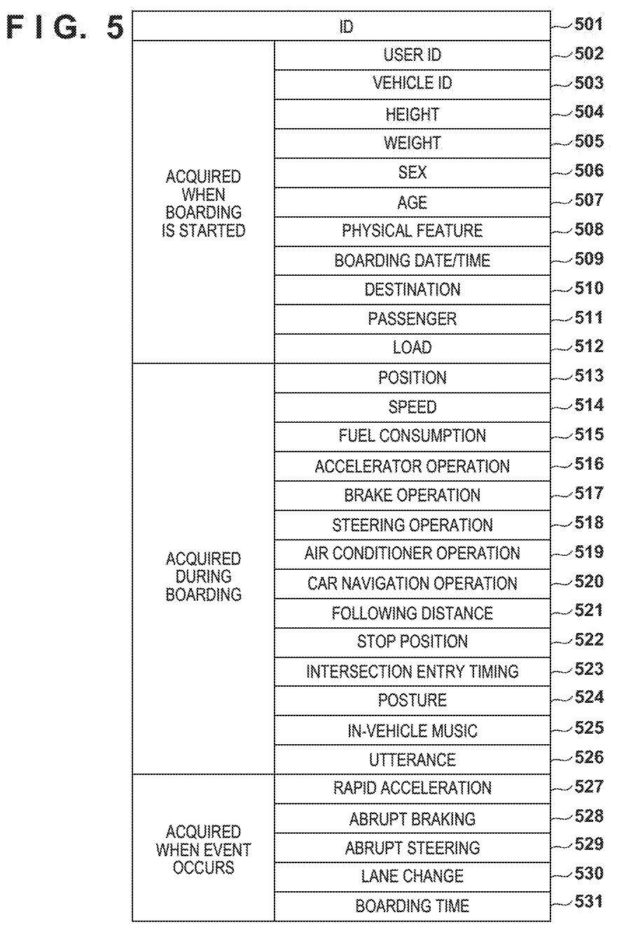

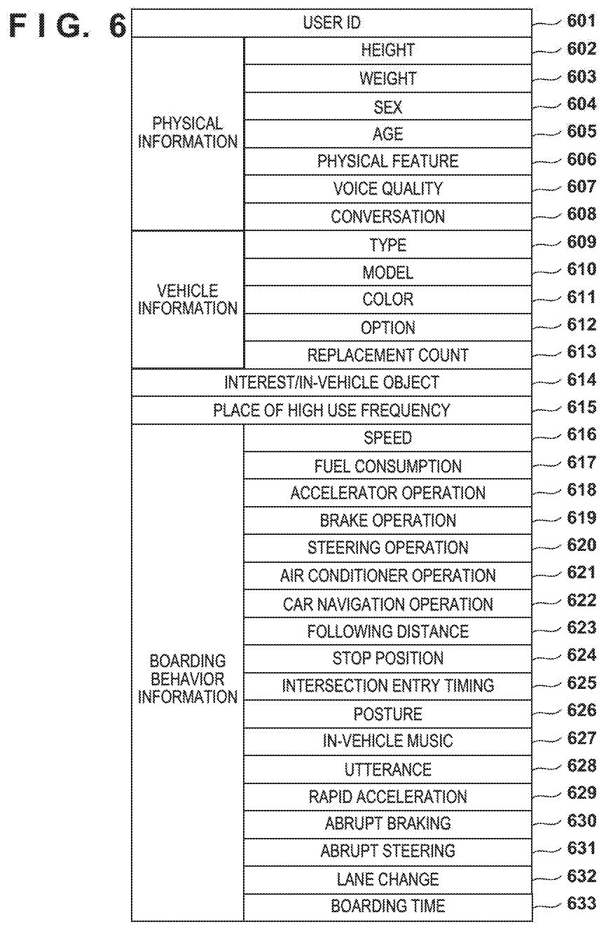

The user information management unit 211 registers user information in a user information database (DB) 231 or updates the registered user information based on boarding history information received from the vehicle 120 or boarding history information stored in a boarding history DB 232. That is, the user information management unit 211 performs user information acquisition processing of reading out user information from the user information DB 231 or user information generation processing of generating user information from boarding history information. The user information stored in the user information DB 231 and the boarding history information stored in the boarding history DB 232 will be described later with reference to FIGS. 5 and 6.

The matching unit 212 performs compatibility determination processing (matching processing) of determining, based on at least the user information stored in the user information DB 231, whether there is another user compatible with the user (request user) who has transmitted the matching request.

The route calculation unit 213 performs route comparison processing of determining, based on at least route information stored in a route information DB 233, whether there is another user who approaches or may approach on the periphery of the scheduled moving route of the request user.

The recommendation providing unit 214 executes matching processing and route calculation processing, generates recommendation information used to recommend, to the request user, another user who is compatible with the request user and may approach on the periphery of the scheduled moving route, and transmits the recommendation information to the vehicle 120 of the request user via the communication unit 220. Note that the recommendation information may include at least part of the user information (another user information) of another user, or may include at least part of the route information of another user.

The route information management unit 215 registers route information in the route information DB 233 or updates the registered route information based on boarding history information received from the vehicle 120 or stored in the boarding history DB 232. That is, the route information management unit 215 executes route information acquisition processing of reading out route information from the route information DB 233 or route information generation processing of generating route information from boarding history information.

The boarding history management unit 216 registers boarding history information in the boarding history DB 232 or updates the registered boarding history information based on boarding history information received from the vehicle of the user. That is, the boarding history management unit 216 executes boarding history acquisition processing of reading out boarding history information from the boarding history DB 232 or boarding history storage processing of storing boarding history information received from the vehicle.

The communication unit 220 is a wired or wireless interface used to communicate with the vehicle 120. The storage unit 230 is a storage medium formed from an HDD (Hard Disk Drive) or the like, and holds various kinds of programs and data. In addition, the storage unit 230 includes the user information DB 231, the boarding history DB 232, the route information DB 233, and a road information DB 234.

The user information DB 231 stores information concerning the user who gets in the vehicle 120. The boarding history DB 232 stores a boarding history received from the vehicle 120 on which the user is boarding.

The route information DB 233 stores information concerning the scheduled traveling route of the vehicle 120 on which the user is currently boarding. Note that in one example, the route information DB 233 can be constituted as part of the user information DB 231. For example, in a case in which the matching server 110 determines that the compatibility is high if the destinations of a plurality of users who are moving are close, matching processing may be performed based on not only information stored in the user information DB 231 but also information stored in the route information DB 233.

The road information DB 234 stores information concerning at least one of a road length, a congestion state, a speed limit, and a peripheral facility, which is used to estimate the time for the user to move on the scheduled moving route. In one example, information stored in the road information DB 234 is also used by the recommendation providing unit 214 to generate recommendation information. For example, when the recommendation providing unit 214 transmits information of another user and information concerning a place where the user may approach to the user who has transmitted the matching request, the place where the user may approach may be designated based on peripheral facility information stored in the road information DB 234.

### Vehicle

FIG. 3 is a block diagram of the vehicle 120 according to this embodiment. Note that a description of mechanisms used by the vehicle 120 to drive, such as an engine mechanism, a suspension mechanism, a steering mechanism, and a power transmission mechanism, will be omitted, and an information processing apparatus 300 for processing information according to this embodiment will be described.

The information processing apparatus 300 includes at least one of an electronic control unit (ECU), an in-vehicle electronic device such as a car navigation system, and a portable terminal such as a smartphone held by the user. The information processing apparatus 300 includes a control unit 310, a communication unit 320, a sensor unit 330, and a notification unit 340. Note that the information processing apparatus 300 may be implemented by a plurality of devices. For example, the ECU may operate as the control unit 310, the communication unit 320, the sensor unit 330, and a storage unit 350, and the car navigation system may operate as the notification unit 340.

The control unit 310 includes a CPU and a RAM (Random Access Memory), and controls the information processing apparatus 300 by executing various kinds of programs stored in the storage unit 350. By executing the various kinds of programs, the control unit 310 functions as a sensor data acquisition unit 311, a matching request unit 312, and a recommendation reception unit 313.

The sensor data acquisition unit 311 acquires, via the sensor unit 330, parameters concerning the mechanisms used by the vehicle 120 to drive, and transmits them to the matching server 110. For example, if the matching server 110 handles information concerning the average speed of the vehicle 120 as user information, the sensor data acquisition unit 311 may acquire the information of the average speed via the sensor unit 330, or may generate the information of the average speed from the information of the speed acquired via the sensor unit 330.

The matching request unit 312 transmits a matching request signal for requesting matching to the matching server 110. As an example, the matching request signal includes the identifier of the user who gets in the vehicle 120 and route information of a traveling schedule.

The recommendation reception unit 313 receives recommendation information from the matching server 110, and makes a notification to the user via the notification unit 340.

The communication unit 320 is a wireless communication interface used to connect the network 130. In an example, the communication unit 320 is a communication device used to perform communication complying with the communication standard of a cellular network or a long distance wireless communication such as satellite communication.

The sensor unit 330 is an interface used to acquire the values of sensors arranged in various kinds of components of the vehicle 120. A value concerning at least one of the current place of the vehicle 120, the steering angle and steering acceleration of a steering wheel, the depression amount of a brake, the depression amount of an accelerator, a vehicle speed, fuel consumption, and a boarding time can be acquired by the sensor unit 330. In an example, the sensor unit 330 acquires information concerning the air volume and temperature of an air conditioner. In addition, the sensor unit 330 can include a seating sensor, a microphone, a pressure sensor, an infrared sensor, and the like.

The sensor unit 330 may include a camera. By a camera (in-camera) arranged in the vehicle, information concerning a driver, a passenger, and a load in the vehicle can be acquired. In addition, by a camera (out-camera) arranged outside the vehicle, at least one of information concerning a road on which the vehicle is traveling, information concerning the state of a traffic signal, and information concerning preceding and following vehicles can be acquired.

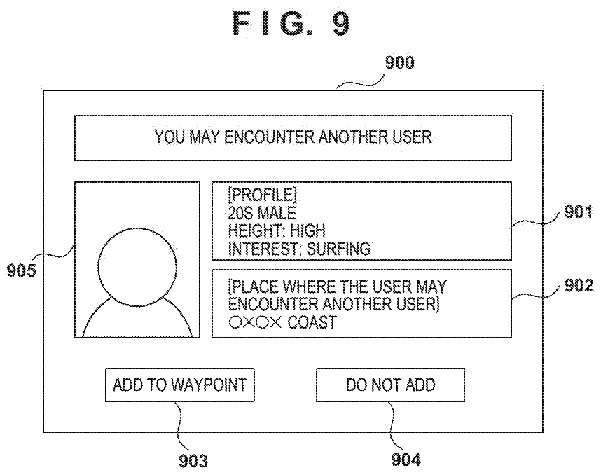

The notification unit 340 notifies the user of recommendation information that the vehicle 120 receives from the matching server 110. The notification unit 340 includes at least one of a speaker (not shown) and a screen (not shown) arranged in the vehicle or car navigation system, and the speaker and the display of a smartphone held by the user. An example in which the notification unit 340 notifies the user of recommendation information via a display will be described later with reference to FIG. 9,

### Example of Processing

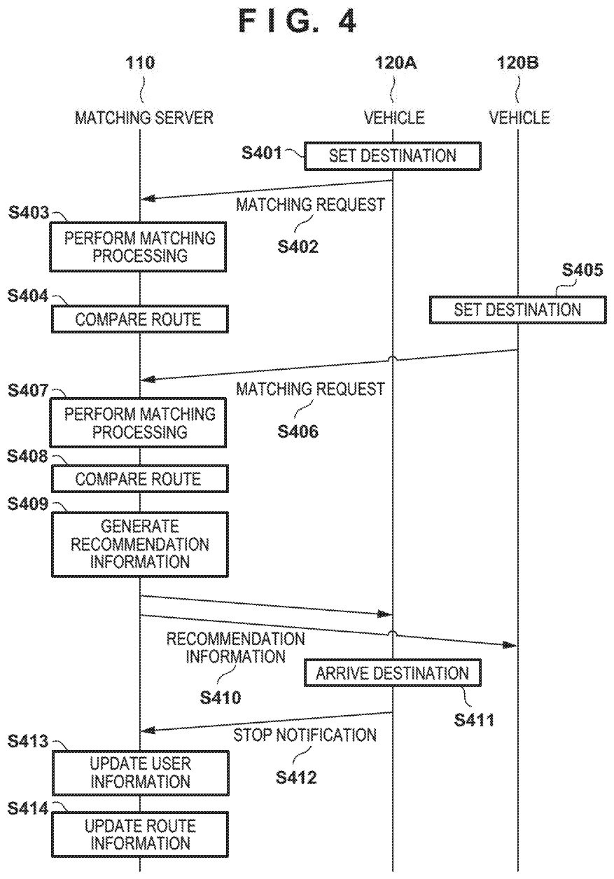

An example of a processing procedure executed by a matching system formed by the matching server 110 and two vehicles 120 (120A and 120B) will be described next with reference to FIG. 4. Note that a user who drives the vehicle 120A will be referred to as a user A, and a user who drives the vehicle 120B will be referred to as a user B.

First, in step S401, the vehicle 120A receives a destination setting from the user A and starts traveling. Next, in step S402, the vehicle 120A transmits a matching request signal to the matching server 110. The matching server 110 that has received the matching request signal advances the process to step S403, and performs matching processing. Here, if the matching server 110 determines, as the result of matching processing, that the compatibility between the user A and the user B is high, the matching server 110 advances the process to step S404, and compares the routes of the users A and B determined to have high compatibility.

Here, since the vehicle 120B does not start traveling, and route information is not registered, the matching server 110 determines that there is no possibility that an approach to the user B is made on the periphery of the route of the user A. For this reason, the matching server 110 ends the processing without transmitting a notification (recommendation information) to the vehicle 120A.

Next, in step S405, the vehicle 120B receives a destination setting from the user B and starts traveling. Next, in step S406, the vehicle 120B transmits a matching request signal to the matching server 110. The matching server 110 that has received the matching request signal advances the process to step S407, and performs matching processing. Here, as in step S403, the matching server 110 determines that the compatibility between the user A and the user B is high. Subsequently, the matching server 110 advances the process to step S408, and executes route comparison processing. Here, upon determining that the scheduled traveling routes of the vehicle 120A and 120B are close, and there is a possibility that they approach on the routes, the matching server 110 advances the process to step S409, and generates a notification. Next, in step S410, the matching server 110 transmits the notification to the vehicles 120A and 120B.

After that, the vehicle 120A is assumed to arrive at the destination in step S411. Then, in step S412, the vehicle 120A transmits a stop notification to the matching server 110. In an example, in step S412, the vehicle 120A may transmit boarding history information representing that the driving or boarding has ended together with the stop notification or in place of the stop notification. Upon receiving the stop notification, in step S413, the matching server 110 updates the user information of the user A to reflect boarding history information corresponding to the boarding of this time on the user information. Next, in step S414, the information of the vehicle 120A is deleted from the route information. Accordingly, reception of recommendation information after the end of traveling is suppressed.

Note that although not illustrated in FIG. 4, the vehicles 120A and 120B transmit the boarding history information at a predetermined timing during traveling. Upon receiving the boarding history information, the matching server 110 updates the boarding history DB 232 using the information.

### Boarding History

An example of a data structure stored in the boarding history DB 232 will be described next.

For the data stored in the boarding history DB 232, an entry is added in each traveling from the start to the end of the engine. One entry includes information concerning a user ID, vehicle ID, height, weight, sex, age, physical feature, boarding date/time, destination, passenger, and load acquired at the start of boarding. In addition, one entry includes information concerning a position, speed, fuel consumption, accelerator operation, brake operation, steering operation, air conditioner operation, car navigation operation, following distance, stop position, intersection entry timing, posture, and in-vehicle music that are parameters continuously acquired during the boarding. Additionally, one entry includes information representing rapid acceleration, abrupt braking, abrupt steering, and lane change as events during the boarding. Furthermore, one entry includes information representing a boarding time that is a parameter acquired at the end of the boarding. That is, the boarding history information includes information of at least one of a behavior of the user when driving the vehicle, a behavior concerning an operation other than driving, and a behavior during the boarding that does not include driving and operations.

These entries are divided into a plurality of data packets and transmitted from the vehicle 120 to the matching server 110. For example, at the start of the boarding, the vehicle 120 transmits a signal including the information concerning the user ID, vehicle ID, height, weight, sex, age, physical feature, boarding date/time, destination, passenger, and load to the matching server 110. Next, during the boarding, a signal including any information acquired during the boarding is transmitted to the matching server 110 at a predetermined interval, at a time when the vehicle temporarily stops, or at a time when the vehicle 120 has traveled a predetermined distance. In addition, if any of the events of rapid acceleration, abrupt braking, abrupt steering, and lane change occurs, information representing the event is transmitted to the matching server 110. When the vehicle 120 stops and stops the engine, the vehicle 120 transmits information representing the boarding time to the matching server 110. The matching server 110 specifies the entry to be updated in the boarding history DB 232 based on the vehicle ID of the vehicle 120 or the ID of the entry itself, and updates the entry based on the received boarding history information. FIG. 5 shows an example of the data structure of an entry stored in the boarding history DB 232.

An ID 501 is an identifier given when an entry is created. A user ID 502 is a user identifier that is the same as a user ID stored in the user information DB 231 to be described later, and is acquired when boarding is started. In an example, the user ID 502 may be specified from image recognition by an in-camera, biometric authentication, or a height, a weight, or the like to be described later. In another example, the user ID 502 may be designated by user input accepted via a car navigation system.

A vehicle ID 503 is the identifier of the vehicle used by the user to travel, and can be acquired from the ECU of the vehicle. Note that the matching server 110 may include a vehicle information DB to specify a model, a vehicle color, vehicle options, and the like from the vehicle ID 503, or the vehicle ID 503 itself may include information representing a model, a vehicle color, and vehicle options.

A height 504 is information representing the height of the user, and is estimated by the information processing apparatus 300 from at least any of data of a sensor configured to acquire the seat position of the driver's seat and an in-camera video. A weight 505 is information representing the weight of the user, and is estimated from, for example, a sensor incorporated in the driver's seat. A physical feature 508 is information representing the appearance feature of the user, for example, the length of hair, hair color, presence/absence of beard, presence/absence of glasses, and the like, and is determined by the information processing apparatus 300 by image analysis of an in-camera image.

A sex 506 is information representing the sex of the user, and is estimated by the information processing apparatus 300 from an in-camera video. The user is asked for confirmation via the car navigation system or the like. An age 507 is information representing the age group of the user, and is determined by the information processing apparatus 300 by image analysis of an in-camera video. The user is asked for confirmation via the car navigation system or the like.

A boarding date/time 509 is information representing the date/time of the start of boarding of the use and the date/time of the end. A destination 510 is a destination input to the car navigation system by the user.

A passenger 511 is information representing how many passengers exist, and is estimated by the information processing apparatus 300 using at least any of data of seat sensors arranged on the passenger seat and the rear seat, a microphone arranged in the vehicle, and the in-camera. A load 512 is information representing a load such as a surfboard, camping goods, or a cage by which the interest of the user is reflected, and is determined by image recognition using the in-camera arranged in the trunk portion of the vehicle 120.

A position 513 is information representing the current place of the vehicle, and is identified based on data from a GPS (Global Positioning System) sensor. In an example, the position 513 may be information representing a traveling route acquired from the car navigation system. A speed 514 is the speed of the vehicle, includes at least one data of the average speed at a predetermined interval, and the maximum speed and the minimum speed within a predetermined period, and is acquired using a vehicle speed sensor. A fuel consumption 515 is information representing how far the vehicle could travel by consuming gasoline, fuel gas, or electric power.

An accelerator operation 516 is information representing the depression amount and the number of times of the accelerator is depressed. A brake operation 517 is information representing the number of times of braking and the depression amount. A steering operation 518 is information representing a steering angle, a steering acceleration, and the manner the steering wheel is gripped. The accelerator operation 516 to the steering operation 518 can be acquired by the ECU via an acceleration sensor and the like. An air conditioner operation 519 is information representing the set air volume, the set wind direction, and the set temperature of the air conditioner. A car navigation operation 520 is information representing the number of operations on the car navigation system and the operation contents.

A following distance 521 is information representing the distance to a preceding vehicle in a case in which the vehicle 120 temporarily stops at an intersection. The following distance 521 can be acquired by a front camera and a millimeter wave radar of the vehicle 120.

A stop position 522 is information representing the stop position of the vehicle 120 with respect to the stop line of an intersection, and can be estimated by image recognition for the front end of the vehicle with respect to the stop line based on the out-camera outside the vehicle. In addition, based on the out-camera, information representing whether the stop of the vehicle 120 is caused by a red signal or by giving a way to a pedestrian may be included.

An intersection entry timing 523 is information representing at which timing the vehicle 120 has entered an intersection and is estimated from the time and the state of a traffic signal captured by the out-camera outside the vehicle. In an example, the intersection entry timing 523 includes only the time of entry to the intersection, and the matching server 110 that has received the time may estimate the state of the traffic signal based on the road information DB 234.

A posture 524 is information representing the boarding posture of the user, and the angles of front inclination and left/right inclinations of the body are acquired based on the set value of the seat position of the driver's seat and an in-camera video. In an example, the information processing apparatus 300 may hold data concerning a standard driving posture, and calculate the degree of deviation representing how far the driving posture of the user deviates from the standard driving posture.

An in-vehicle music 525 is information concerning a sound reproduced by a radio, the CD player function of the car navigation system, or external input. An utterance 526 is information concerning a conversation or voice quality of the user recorded by a microphone arranged in the vehicle.

Rapid acceleration 527 includes information concerning a date/time and acceleration. If an accelerator operation is performed, and the change amount of the acceleration is a predetermined value or more, the information processing apparatus 300 determines that rapid acceleration is performed, generates boarding history information including the rapid acceleration 527, and transmits it to the matching server 110. Abrupt braking 528 includes information concerning a date/time and acceleration. If a braking operation is performed, and the change amount of the acceleration is a predetermined value or more, the information processing apparatus 300 determines that abrupt braking is performed, generates boarding history information including the abrupt braking 528, and transmits it to the matching server 110. Abrupt steering 529 includes information concerning a date/time and the steering angle and steering acceleration of the steering wheel. If a steering operation is performed, and the change amount of the acceleration is a predetermined value or more, the information processing apparatus 300 determines that the user performs abrupt steering, generates boarding history information including the abrupt steering 529, and transmits it to the matching server 110.

A lane change 530 includes information concerning a date/time. Upon determining, based on an in-vehicle camera and a steering angle, that a lane change is performed, the information processing apparatus 300 generates boarding history information including the lane change 530, and transmits it to the matching server 110. In an example, the lane change 530 may include information representing whether a lighting device is ON at the time of the lane change and the lighting time of the lighting device.

A boarding time 531 is information transmitted at the time of engine stop, and includes information representing the time of driving or boarding of the user.

Note that the timing of transmitting each information may be changed. For example, all pieces of information may be transmitted together when driving ends. Boarding history information to be transmitted may be changed depending on whether the user drives the vehicle. For example, if the user drives the vehicle, the vehicle transmits all pieces of information shown in FIG. 5. On the other hand, if the user gets in an automated driving vehicle but does not drive, the automated driving vehicle may transmit boarding history information that does not include, for example, the accelerator operation 516 to the intersection entry timing 523 in FIG. 5.

In addition, as for information acquired during boarding and information concerning an event, if a plurality of pieces of information are transmitted, all values are recorded. For example, if information “12:03:52” is registered in the lane change 530 of one entry, and the matching server 110 receives boarding history information “12:05:08” next, the matching server 110 updates the information of the lane change 530 to “12:03:52, 12:05:08”.

Additionally, the information processing apparatus 300 may transmit the destination 510 again to change the destination 510. In such a case, the matching server 110 updates the boarding history information by the destination 510 that is finally transmitted before the end of driving. Accordingly, even if the engine of the vehicle 120 is stopped to take a rest in a place different from the destination before arriving at the destination, the matching server 110 acquires the information peripheral facilities, thereby recording the place where the stop is made and updating the destination 510.

### User Information

An example of a data structure stored in the user information DB 231 will be described next with reference to FIG. 6.

An entry of the user information DB 231 includes a user ID 601, physical information, vehicle information, an interest/in-vehicle object 614, a place 615 of high use frequency, and boarding behavior information. The physical information includes a height 602, a weight 603, a sex 604, an age 605, a physical feature 606, a voice quality 607, and a conversation 608. In this specification, the boarding behavior information, the physical information, the vehicle information, information about the interest/in-vehicle object, and information about the place of high use frequency are included in boarding characteristic information.

The height 602 to the physical feature 606 are information representing the height, weight, and physical feature of the user, which are decided based on the height 504 to the physical feature 508 in the boarding history DB 232. The voice quality 607 is classified into one of groups such as “high”, “low”, and “low and cool” based on the utterance 526 in the boarding history DB 232. The conversation 608 is classified into “talkative”, “quiet”, “shy”, or the like based on the utterance 526 in the boarding history DB 232.

The vehicle information is information concerning the user's taste for a vehicle based on the vehicle information of a vehicle the user has purchased or rented ever, and includes a type 609, a model 610, a color 611, an option 612, and a replacement count 613. The type 609 has a value representing the type of a vehicle such as “compact car” or “minivan”. The model 610 includes information such as a vehicle name representing a specific model. The option 612 is information representing optional equipment in the vehicle driven by the user, such as “drive recorder” and “snowboard attachment”. The replacement count 613 is information representing the number of times of vehicle replacement by the user.

The interest/in-vehicle object 614 is information representing the interest of the user or an object that is often loaded, which can be estimated from boarding history information. For example, if there are many entries including a surfboard in the load 512, “surfing” is set in the interest/in-vehicle object 614. In another example, if there are many entries including a sports gym in the destination 510, “muscle training” is set in the interest/in-vehicle object 614.

The place 615 of high use frequency is information representing an area the user frequently visits, and is estimated based on the destination 510 or the position 513 in the boarding history information. The place 615 of high use frequency may be the name of a facility the user frequently visited or a value “◯◯ town” representing the living area of the user.

Pieces of boarding behavior information from a speed 616 to a boarding time 633 have values set based on the boarding history.

For example, in the speed 616, a value “relatively fast” or “relatively slow” is set based on a speed limit for a road or a speed relative to a traveling lane obtained from the speed 514 and the position 513 in the boarding history. In an example, a tag may be added to the speed 616 in comparison with the speed 514 of another user traveling at the position 513 on the periphery.

For the fuel consumption 617 as well, a value such as “eco” or “prioritize speed” is set based on the speed 514 and the fuel consumption 515 in the boarding history. For the accelerator operation 618, the brake operation 619, and the steering operation 620 as well, it is determined based on the boarding history whether the user is “careful”, “rough”, or the like. Additionally, according to the set temperature of the air conditioner operation 519, it is determined whether the user is “sensitive to cold”, “sensitive to heat”, or the like.

In addition, it is determined that the user is “impatient” if the following distance 521 is short, or it is determined that the user is “kind” if he/she yields to a pedestrian in the stop position 522. If it is determined based on the intersection entry timing 523 that the user often enters an intersection at a yellow signal, a value such as “impatient” is set in the intersection entry timing 625. If the driving posture is the same as the standard posture in the posture 524, a value such as “stick to basics” is set in the posture 626.

Similarly, each of the in-vehicle music 627 to the boarding time 633 is also classified into a plurality of groups based on the boarding history information.

Note that user information including the boarding characteristic information of a certain user is generated based on all pieces of boarding history information of the user. However, for example, since the driving behavior of a user is considered to change as he/she gets used to driving, boarding history information may be weighted to make the influence of new boarding history information large. In addition, the physical information may be generated based on only latest boarding history information. This makes it possible to follow a change in the hair style.

It is considered that the boarding behavior of the user changes depending on the passenger. For example, the boarding behavior of the user is readily disclosed when he/she is alone. However, if a person the user does not know well is in the vehicle, the user is considered to be often boarding with a better boarding behavior. For this reason, the collected boarding history information may be weighted in accordance with the passenger.

### Route Information

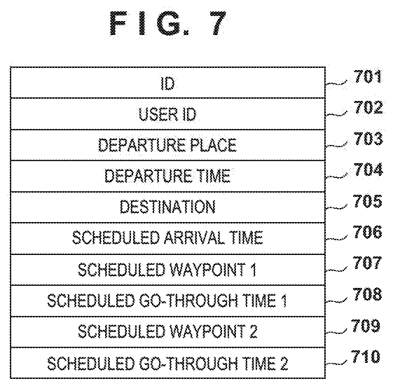

An example of a data structure stored in the route information DB 233 will be described next with reference to FIG. 7.

The route information includes an ID 701, a user ID 702, a departure place 703, and a departure time 704. The route information also includes a destination 705, a scheduled arrival time 706, and a combination of scheduled waypoints and scheduled go-through times represented as a scheduled waypoint 1 707, a scheduled go-through time 1 708, a scheduled waypoint 2 709, and a scheduled go-through time 2 710 in FIG. 7.

The ID 701 indicates the identifier of route information. The user ID 702 represents for which user the route information is set. The departure place 703 and the departure time 704 include information of a departure point where the user starts boarding and a departure time, respectively. The destination 705 is the destination input to the car navigation system by the user. The scheduled arrival time 706 represents a scheduled moving time at which the user arrives at the destination. The departure place 703, the departure time 704, and the destination 705 are determined based on the boarding date/time 509, the destination 510, and the position 513 in the boarding history information.

The scheduled waypoint is a point through which the user is scheduled to pass from the departure place to the destination. In an example, the scheduled waypoint may be a point on a road such as an intersection, may be a predetermined facility, or may be specific GPS coordinates. The scheduled go-through time is a scheduled moving time at which the user passes via or through the scheduled waypoint.

The scheduled arrival time, the scheduled waypoints, and the scheduled go-through times may be decided by the matching server 110 based on the departure place, the departure time, the destination, and the road information DB 234, or may be decided by a navigation server different from the matching server 110.

### Example of Processing of Matching Server

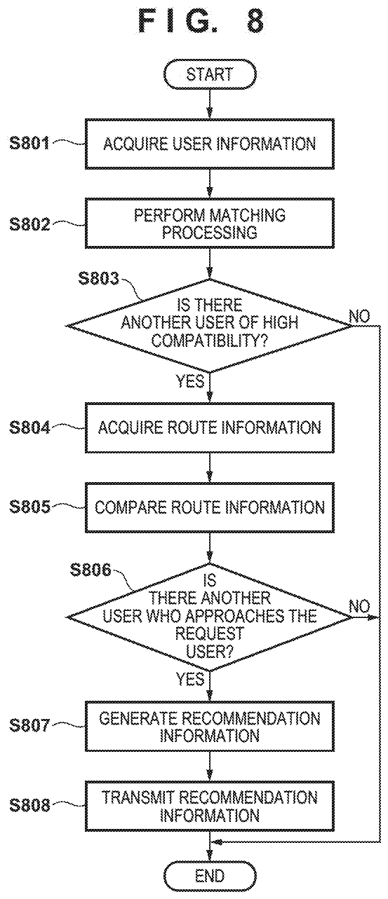

An example of processing performed by the matching server 110 will be described next with reference to FIG. 8. Note that the processing shown in FIG. 8 is executed when the matching server 110 receives a matching request signal or boarding history information from the vehicle 120. In an example, the control unit 210 executes a program stored in the storage unit 230, thereby implementing the processing of the matching server 110.

First, in step S801, the control unit 210 acquires user information from the user information DB 231. Next, the control unit 210 advances the process to step S802, and performs matching processing between a user (request user) who is boarding on the vehicle 120 that has transmitted the matching request signal or boarding history information and another user.

In an example, in the matching processing of step S802, the compatibility between the request user and the other user is determined based on whether the pieces of user's boarding characteristic information including at least one of the physical information of the user, vehicle information, interest, a place of high use frequency, and boarding behavior information are similar, thereby performing matching. For example, for another user whose type 609 of the vehicle he/she frequently drives or gets in is the same as that of the request user, it is determined that the taste is similar, and the compatibility is high. Another user having the same interest 614 as the request user is also determined to have high compatibility. In addition, for another user whose brake operation 619 of boarding behavior information is “careful” and the same as that of the request user, the matching server 110 determines that the compatibility is high because of the similar personalities.

Additionally, in an example, in the matching processing of step S802, compatibility may be determined based on the taste of user information set by the request user in advance. For example, a request user who wants an encounter with another user whose height 602 is “high” may be able to set, in the matching server 110 in advance, that he/she prefers another user who is tall. Upon determining that the height 602 of another user is high, the matching server 110 determines that the compatibility with the other user is high.

Additionally, in an example, in the matching processing of step S802, the compatibility may be determined based on that at least any of the pieces of user information including the boarding characteristic information of the user is different. For example, the matching server 110 determines that a user for which the conversation 608 in the user information is “a listener” is compatible with a user for which the conversation 608 is “talkative”.

In addition, the matching server 110 determines that a user for which the place 615 of high use frequency does not include the destination is compatible with a user for which the place 615 of high use frequency includes the user. This allows a user who visits a certain place for the first time in travel or the like to approach another user who knows the neighborhood of the place well, and the probability of encounter with the user who has never encountered can be increased.

Note that in the matching processing of step S802, a compatibility database representing user information obtained by analyzing the compatibility with the request user may be constructed in advance, and the user information of another user may be collated with the database to calculate the compatibility.

In addition, in the matching processing of step S802, all pieces of information in the user information need not be compared, and the priority of user information to be used in the matching processing may arbitrarily be set by the user. For example, a user who wants to find another user of high compatibility based on the in-vehicle music 627 may do a setting not to consider user information other than the in-vehicle music 627. Alternatively, the user information to be used in the matching processing may arbitrarily be selected or weighted by the user.

When the matching processing of step S802 ends, the matching server 110 advances the process to step S803 to determine whether another user of high compatibility exists. In an example, in the matching processing of step S802, compatibility may be calculated as a numerical value for each of other users, and another user having a compatibility value equal to or more than a threshold may be extracted.

Upon determining in step S803 that another user of high compatibility exists (YES in step S803), the matching server 110 advances the process to step S804. Upon determining that another user of high compatibility does not exist (NO in step S803), the matching server 110 ends the processing.

In step S804, the matching server 110 acquires the route information of the request user and that of another user who is compatible with the request user from the route information DB 233. Next, the matching server 110 advances the process to step S805 to compare the route information of the request user with the route information of the other user and determine whether the user approaches within a predetermined range on the periphery of the scheduled moving route of the request user.

In the processing of step S805, the routes are compared by determining whether the distance between any of the current place, the scheduled waypoint, and the destination of the request user and any of the current place, the scheduled waypoint, and the destination of another user falls within a predetermined distance. For example, the matching server 110 may determine that another user for which any of the current place, the scheduled waypoint, and the destination is included within 1 km from any point of the current place, the scheduled waypoint, and the destination of the request user is a user who approaches the request user.

In an example, not only the scheduled waypoints and the destinations of the request user and another user but also the scheduled go-through times and the scheduled arrival times may be taken into consideration. For example, another user who is scheduled to exist within a radius of 1 km from the destination in 10 min before and after the scheduled arrival time of the request user may be determined as a user who approaches. This can determine whether the possibility that the request user and the other user encounter is high.

Next, the matching server 110 advances the process to step S806 to determine whether another user who approaches the request user exists. Upon determining that another user who approaches exists (YES in step S806), the matching server 110 advances the process to step S807. Upon determining that another user who approaches does not exist (NO in step S806), the processing shown in FIG. 8 is ended.

In step S807, the matching server 110 generates recommendation information including at least part of any of the user information, the route information, and the boarding history information of the other user. For example, the recommendation information includes the information of the vehicle that the other user is currently driving. This allows the request user notified of the recommendation information to search for another user of high compatibility based on the feature of the vehicle 120.

Note that the user can designate user information that should not be made open in the user information of his/her own. This can prevent individual information unwanted by the user from being included in the recommendation information.

Note that recommendation information including at least part of any of the user information, the route information, and the boarding history information of the request user is also generated for the other user.

Next, the matching server 110 advances the process to step S808 to transmit the recommendation information to the request user and another user who is compatible with the request user. As described above, the recommendation information transmitted to the request user and the recommendation information transmitted to the other user are different.

### Example of Notification

An example of a screen (recommendation screen) displayed on the notification unit 340 by the vehicle 120 that has received the recommendation information will be described next with reference to FIG. 9.

A description will be made assuming that a recommendation screen 900 is displayed on the display of the car navigation system arranged in the vehicle 120. However, it may be displayed on the display of the portable terminal of the user, as described above. In addition, the recommendation information may be notified by a voice.

A recommendation screen 900 includes a user information region 901, a route information region 902, an “add to waypoint” button 903, and a “do not add” button 904.

The user information region 901 displays at least part of the user information of another user. Information displayed in the user information region 901 includes not only the age, sex, height, and weight of the other user but also any of user information determined to be compatible with the request user. In the example of FIG. 9, the information of the interest 614 is displayed in addition to the biological information of the user. In the route information region 902, a scheduled waypoint or a destination where the user may encounter another user is displayed.

When the user presses the “add to waypoint” button 903, a place with the possibility of encounter is added to the waypoint of the car navigation system of the user, and navigation is started. When the user presses the “do not add” button 904, display of the recommendation screen 900 is ended.

### Other Embodiments

In this embodiment, it is determined based on user information including the boarding characteristic of each user whether the compatibility of a plurality of users who are driving is high, and upon determining that the compatibility is high, the traveling routes are compared. However, it may be determined whether the compatibility of a user who is boarding and a user who is not boarding is high, and upon determining that the compatibility is high, the traveling route of the user who is boarding and the current place of the user who is not boarding may be compared. This allows even a user who is not presently driving or boarding to receive recommendation information and move to a place where the user may encounter a compatible user. In this case, the notification from the matching server 110 is transmitted to the portable terminal of the user. In addition, the route information DB 233 may store position information (scheduled position information) where the user is scheduled to stay at a predetermined time.

In this embodiment, after matching processing of a plurality of users is performed, route comparison processing of comparing the routes of compatible users is performed. However, the order may be reversed. That is, after route comparison processing is performed to determine users who approach on the periphery of a route, matching processing may be performed to determine compatible users in the users who approach. Alternatively, the matching processing and the route comparison processing may be executed in parallel. The order of performing the matching processing and the route comparison processing may be decided in consideration of the load of each process.

### Summary of Embodiment

1. A matching method according to the above-described embodiment is a method executed by a matching server configured to perform matching of a vehicle user, characterized by comprising a user information acquisition step of acquiring first user information (for example, FIG. 6) including boarding characteristic information of a first user and second user information including boarding characteristic information of a second user, a compatibility determination step (for example, S802) of determining, based on the first user information and the second user information acquired in the user information acquisition step, whether compatibility between the first user and the second user is high, a moving schedule information acquisition step of acquiring information (for example, FIG. 7) concerning a position of a moving schedule of each of the first user and the second user, a position comparison step (for example, S805) of determining whether there is a possibility that the first user approaches the second user within a predetermined range of the position of the moving schedule of the first user acquired in the moving schedule information acquisition step, and a notification step (for example, S808) of providing, to the first user, information concerning the second user for which it is determined in the compatibility determination step that the compatibility is high, and it is determined in the position comparison step that there is the possibility that the approach occurs.

Accordingly, it is possible to provide a chance to an encounter of users based on information associated with a vehicle a user drives or gets in.

2. The matching method according to the above-described embodiment is characterized in that in the notification step, the information concerning the second user includes part of the second user information.

Accordingly, the user who receives the notification can acquire detailed information of another user who may approach.

3. The matching method according to the above-described embodiment is characterized in that in the notification step, the information concerning the second user includes information concerning a position with the possibility that the approach to the second user occurs.

Accordingly, the user who receives the notification can know where another user who may approach exists.

4. The matching method according to the above-described embodiment is characterized in that the boarding characteristic information includes at least any of physical information, information concerning a vehicle the user gets in, an interest and an in-vehicle object, a place of high use frequency, and a boarding behavior.

Accordingly, it is possible to determine the compatibility between the users based on at least any of the physical information, of the user, the information concerning the vehicle the user gets in, the information of the interest and the in-vehicle object, the information concerning the place of high use frequency, and the boarding behavior information.

5. The matching method according to the above-described embodiment is characterized by further comprising a user information generation step of generating the first user information based on boarding history information received from a vehicle the first user gets in.

Accordingly, it is possible to generate the user information without user input.

6. The matching method according to the above-described embodiment is characterized by further comprising a position information generation step of generating position information of the moving schedule based on boarding history information received from a vehicle the first user gets in.

Accordingly, it is possible to generate the position information without user input.

7. The matching method according to the above-described embodiment is characterized in that in the compatibility determination step, upon determining that any of the boarding behavior information of the first user and any of the boarding behavior information of the second user are similar, the matching server determines that the compatibility between the first user and the second user is high.

Accordingly, it is possible to provide a chance to an encounter of compatible users based on a behavior during boarding.

8. The matching method according to the above-described embodiment is characterized in that in the position comparison step, upon determining that the second user moves within the predetermined range from the position of the moving schedule of the first user within a predetermined time from a scheduled moving time of the first user, the matching server determines that there is the possibility that the first user and the second user approach.

Accordingly, it is possible to determine users who approach at a high possibility because they exist in the same range in the same time zone.

9. The matching method according to the above-described embodiment is characterized in that the boarding history information includes information concerning a load of a vehicle the first user gets in.

Accordingly, it is possible to estimate the interest of the user based on the load of the vehicle the user gets in.

10. The matching method according to the above-described embodiment is characterized in that the boarding history information includes at least any of a depression amount of an accelerator of a vehicle the first user gets in, the number of times the accelerator is depressed, a depression amount of a brake, the number of times of the brake is depressed, a steering angle, and a steering acceleration.

Accordingly, it is possible to determine the compatibility between the users based on the operation history of at least any of the accelerator, the brake, and the steering wheel.

11. The matching method according to the above-described embodiment is characterized in that the information concerning the vehicle the user gets in includes information of at least any of a model, a color, a vehicle name, and an option concerning a vehicle the first user ever got in.

Accordingly, it is possible to determine the compatibility between users based on information concerning a vehicle the user likes.

12. The matching method according to the above-described embodiment is characterized in that in the notification step, the matching server provides information of at least any of a model, a color, a vehicle name, and an option concerning a vehicle the second user gets in.

Accordingly, the user who receives the notification can obtain information concerning the vehicle of another user of high compatibility and search for another user of high compatibility based on the notification.

13. A matching server (for example, 110) according to the above-described embodiment is a matching server configured to perform matching of a vehicle user, characterized by comprising user information acquisition means for acquiring first user information including boarding characteristic information of a first user and second user information including boarding characteristic information of a second user, compatibility determination means for determining, based on the first user information and the second user information acquired by the user information acquisition means, whether compatibility between the first user and the second user is high, position information acquisition means for acquiring information concerning a scheduled moving position of each of the first user and the second user, position comparison means for determining whether there is a possibility that the first user approaches the second user within a predetermined range of the scheduled moving position of the first user acquired by the position information acquisition means, and notification means for providing, to the first user, information concerning the second user for which it is determined by the compatibility determination means that the compatibility is high, and it is determined by the position comparison means that there is the possibility that the approach occurs.

Accordingly, it is possible to provide a chance to an encounter of users based on information associated with a vehicle a user drives or gets in.

14. A matching system according to the above-described embodiment is a matching system formed by a vehicle and a matching server configured to perform matching of a vehicle user, characterized in that the vehicle (for example, 120) comprises a transmission means for transmitting boarding history information of a first user to the matching server (for example, 110), and the matching server comprises generation means for generating first user information including boarding characteristic information of the first user based on the received boarding history information, user information acquisition means for acquiring second user information including boarding characteristic information of a second user, compatibility determination means for determining, based on the first user information and the second user information acquired by the user information acquisition means, whether compatibility between the first user and the second user is high, position information acquisition means for acquiring position information concerning a scheduled moving position of each of the first user and the second user, position comparison means for determining whether there is a possibility that an approach to the second user occurs within a predetermined range of the scheduled moving position of the first user acquired by the position information acquisition means, and notification means for providing, to the first user, information concerning the second user for which it is determined by the compatibility determination means that the compatibility is high, and it is determined by the position comparison means that there is the possibility that the approach occurs.

Accordingly, it is possible to provide a chance to an encounter of users based on information associated with a vehicle a user drives or gets in.

15. A program according to the above-described embodiment is characterized by causing a computer to execute a matching method of any one of the above-described embodiments 1 to 11.

Accordingly, it is possible to provide a chance to an encounter of users based on information associated with a vehicle a user drives or gets in.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

What is claimed is:

1. A matching method executed by a matching server configured to perform matching of a vehicle user, comprising:
acquiring first user information including boarding characteristic information of a first user and second user information including boarding characteristic information of a second user;
determining, based on the first user information and the second user information acquired in the acquiring first user information and the second user information, whether compatibility between the first user and the second user is high;
acquiring information concerning a position of a moving schedule of each of the first user and the second user;
determining whether there is a possibility that the first user approaches the second user within a predetermined range of the position of the moving schedule of the first user acquired in the acquiring the information concerning the position of the moving schedule; and
providing, to the first user, information concerning the second user for which it is determined in the determining whether the compatibility is high, that the compatibility is high, and it is determined in the determining whether there is the possibility that there is the possibility that the approach occurs.

2. The matching method according to claim 1, wherein in the providing the information concerning the second user to the first user, the information concerning the second user includes part of the second user information.

3. The matching method according to claim 1, wherein in the providing the information concerning the second user to the first user, the information concerning the second user includes information concerning a position with the possibility that the approach to the second user occurs.

4. The matching method according to claim 1, further comprising generating the first user information based on boarding history information received from a vehicle the first user gets in.

5. The matching method according to claim 1, further comprising generating position information of the moving schedule based on boarding history information received from a vehicle the first user gets in.

6. The matching method according to claim 1, wherein the boarding characteristic information includes at least any of physical information, information concerning a vehicle the user gets in, information of an interest and an in-vehicle object, information concerning a place of high use frequency, and boarding behavior information.

7. The matching method according to claim 6, wherein in the determining whether the compatibility is high, upon determining that any of the boarding behavior information of the first user and any of the boarding behavior information of the second user are similar, the matching server determines that the compatibility between the first user and the second user is high.

8. The matching method according to claim 1, wherein in the determining whether there is the possibility, upon determining that the second user moves within the predetermined range from the position of the moving schedule of the first user within a predetermined time from a scheduled moving time of the first user, the matching server determines that there is the possibility that the first user and the second user approach.

9. The matching method according to claim 4, wherein the boarding history information includes information concerning a load of a vehicle the first user gets in.

10. The matching method according to claim 4, wherein the boarding history information includes at least any of a depression amount of an accelerator of a vehicle the first user gets in, the number of times of the accelerator is depressed, a depression amount of a brake, the number of times of the brake is depressed, a steering angle, and a steering acceleration.

11. The matching method according to claim 6, wherein the information concerning the vehicle the user gets in includes information of at least any of a model, a color, a vehicle name, and an option concerning a vehicle the first user ever got in.

12. The matching method according to claim 1, wherein in the providing the information concerning the second user to the first user, the matching server provides information of at least any of a model, a color, a vehicle name, and an option concerning a vehicle the second user gets in.

13. A matching server configured to perform matching of a vehicle user, comprising:
a user information acquisition unit configured to acquire first user information including boarding characteristic information of a first user and second user information including boarding characteristic information of a second user;
a compatibility determination unit configured to determine, based on the first user information and the second user information acquired by the user information acquisition unit, whether compatibility between the first user and the second user is high;
a position information acquisition unit configured to acquire information concerning a scheduled moving position of each of the first user and the second user;
a position comparison unit configured to determine whether there is a possibility that the first user approaches the second user within a predetermined range of the scheduled moving position of the first user acquired by the position information acquisition unit; and
a notification unit configured to provide, to the first user, information concerning the second user for which it is determined by the compatibility determination unit that the compatibility is high, and it is determined by the position comparison unit that there is the possibility that the approach occurs.

14. A matching system formed by a vehicle and a matching server configured to perform matching of a vehicle user,
the vehicle comprising:
a transmission unit configured to transmit boarding history information of a first user to the matching server, and
the matching server comprising:
a generation unit configured to generate first user information including boarding characteristic information of the first user based on the received boarding history information;
a user information acquisition unit configured to acquire second user information including boarding characteristic information of a second user;
a compatibility determination unit configured to determine, based on the first user information and the second user information acquired by the user information acquisition unit, whether compatibility between the first user and the second user is high;
a position information acquisition unit configured to acquire position information concerning a scheduled moving position of each of the first user and the second user;
a position comparison unit configured to determine whether there is a possibility that an approach to the second user occurs within a predetermined range of the scheduled moving position of the first user acquired by the position information acquisition unit; and
a notification unit configured to provide, to the first user, information concerning the second user for which it is determined by the compatibility determination unit that the compatibility is high, and it is determined by the position comparison unit that there is the possibility that the approach occurs.

15. A storage medium storing a program configured to cause a computer to execute a matching method,
wherein the matching method is a method executed by a matching server configured to perform matching of a vehicle user, comprising:
acquiring first user information including boarding characteristic information of a first user and second user information including boarding characteristic information of a second user;
determining, based on the first user information and the second user information acquired in the acquiring first user information and the second user information, whether compatibility between the first user and the second user is high;
acquiring information concerning a position of a moving schedule of each of the first user and the second user;
determining whether there is a possibility that the first user approaches the second user within a predetermined range of the position of the moving schedule of the first user acquired in the acquiring the information concerning the position of the moving schedule; and
providing, to the first user, information concerning the second user for which it is determined in the determining whether the compatibility is high, that the compatibility is high, and it is determined in the determining whether there is the possibility that there is the possibility that the approach occurs.

16. A storage medium storing a program configured to cause a computer to execute a matching method,
wherein the matching method is a method executed by a matching server configured to perform matching of a vehicle user, comprising:
acquiring first user information including boarding characteristic information of a first user and second user information including boarding characteristic information of a second user;
determining, based on the first user information and the second user information acquired in the acquiring first user information and the second user information, whether compatibility between the first user and the second user is high;
acquiring information concerning a position of a moving schedule of each of the first user and the second user;
determining whether there is a possibility that the first user approaches the second user within a predetermined range of the position of the moving schedule of the first user acquired in the acquiring the information concerning the position of the moving schedule; and
providing, to the first user, information concerning the second user for which it is determined in the determining whether the compatibility is high, that the compatibility is high, and it is determined in the determining whether there is the possibility that there is the possibility that the approach occurs, and
in the providing the information concerning the second user to the first user, the information concerning the second user includes part of the second user information.
